(19) United States
(12) Patent Application Publication
(10) Pub. No.: US 2025/0279832 A1
(43) Pub. Date: Sep. 4, 2025

(54) AUTOMATIC VARIABLE TILT APPARATUS, OPTICAL SIGNAL GAIN EQUALIZATION METHOD, AND NON-TRANSITORY COMPUTER READABLE MEDIUM

(71) Applicant: NEC Corporation, Tokyo (JP)

(72) Inventor: Koji INADA, Tokyo (JP)

(73) Assignee: NEC Corporation, Tokyo (JP)

(21) Appl. No.: 19/052,348

(22) Filed: Feb. 13, 2025

(30) Foreign Application Priority Data
Feb. 29, 2024 (JP) 2024-029693

(51) Int. Cl. H04B 10/2507; H04B 10/25

(52) U.S. Cl. CPC H04B 10/2507; H04B 10/2589

(57) ABSTRACT

An automatic variable tilt apparatus includes: a first Fi/Fo device configured to separate a multicore optical input signal into two single core optical input signals; two variable tilt equalizers configured to respectively adjust tilt levels of the two single core optical input signals; two optical couplers configured to respectively divide two single core optical output signals from the two variable tilt equalizers into two optical signals in a predetermined proportion; a feedback controller configured to perform feedback control on the associated variable tilt equalizer, based on a tilt level of one of the single core optical output signals being divided by each of the two optical couplers; and a second Fi/Fo device configured to multiplex another of the single core optical output signals being divided by each of the two optical couplers, and output a multiplexed multicore optical output signal.

### INCORPORATION BY REFERENCE

This application is based upon and claims the benefit of priority from Japanese patent application No. 2024-029693, filed on Feb. 29, 2024, the disclosure of which is incorporated herein in its entirety by reference.

### TECHNICAL FIELD

The present disclosure relates to an automatic variable tilt apparatus and an optical signal gain equalization method that are used for a multicore fiber, and a non-transitory computer readable medium, and particularly relates to an automatic variable tilt apparatus and an optical signal gain equalization method that are used in an optical submarine system of a multicore system, and a non-transitory computer readable medium.

### BACKGROUND ART

An equalization apparatus that equalizes an inclination level of an optical signal used in a submarine cable system (optical submarine system), a communication system, and an equalization method have been known (for example, see International Patent Publication No. 2019/167736). The equalization apparatus disclosed in International Patent Publication No. 2019/167736 includes an equalizer group including at least two equalizers for reducing the number of optical devices while a setting number of inclination levels is maintained.

In an optical submarine system, an optical signal in a signal bandwidth of a C band is currently used in an optical fiber of a single core (single mode fiber (SMF) on which only one core is mounted). Thus, in order to increase communication capacity of the optical submarine system, the number (core number) of optical fibers to be mounted needs to be increased.

However, in an optical submarine system in which the number of optical fibers that can be mounted on an optical submarine cable is limited due to a cross section of an optical fiber and the like, there are problems that the number of optical fibers is difficult to increase and a manufacturing cost also becomes massive.

### SUMMARY

The present disclosure has been made in order to solve such problems, and an example object of the present disclosure is to provide an automatic variable tilt apparatus and an optical signal gain equalization method that can automatically adjust a tilt level (inclination) of an optical profile being an optical input signal in a short time in an optical submarine system using a multicore fiber, and provide a non-transitory computer readable medium.

In a first example aspect, an automatic variable tilt apparatus according to the present disclosure includes:
a first fan-in/fan-out device configured to separate a multicore optical input signal from a multicore fiber into two single core optical input signals;
two variable tilt equalizers configured to respectively adjust tilt levels of the two single core optical input signals;
two optical couplers configured to respectively divide two single core optical output signals from the two variable tilt equalizers into two optical signals in a predetermined proportion;
a feedback controller configured to perform feedback control on the associated variable tilt equalizer, based on a tilt level of one of the single core optical output signals being divided by each of the two optical couplers; and
a second fan-in/fan-out device configured to multiplex another of the single core optical output signals being divided by each of the two optical couplers, and output a multiplexed multicore optical output signal.

In a second example aspect, an optical signal gain equalization method according to the present disclosure includes:
by a first fan-in/fan-out device, separating a multicore optical input signal from a multicore fiber into two single core optical input signals;
inputting each of the two single core optical input signals to two variable tilt equalizers;
by each of two optical couplers, dividing a single core optical output signal from the associated variable tilt equalizer into two optical signals in a predetermined proportion;
performing feedback control on the associated variable tilt equalizer, based on a tilt level of one of the single core optical output signals being divided by each of the two optical couplers; and,
by a second fan-in/fan-out device, multiplexing another of the single core optical output signals being divided by each of the two optical couplers, and outputting a multiplexed multicore optical output signal.

In a third example aspect, a non-transitory computer readable medium according to the present disclosure that stores a program causes a computer to execute:
extracting an optical signal having a specific wavelength from a part of each of two single core optical input signals being separated from a multicore optical input signal by a fan-in/fan-out device;
converting two optical signals having the specific wavelength into two electrical signals;
analyzing a tilt level of each of the two single core optical input signals, based on the two electrical signals;
each selecting one tilt equalizer from a plurality of tilt equalizers in each of two variable tilt equalizers, based on a target tilt level stored in a memory and an analysis result by the analysis, and switching to the selected one tilt equalizer; and
multiplexing two optical output signals being output from the two variable tilt equalizers after the switching, and outputting a multiplexed multicore optical output signal.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration example of an automatic variable tilt apparatus according to the present disclosure;

FIGS. 2A and 2B are diagrams illustrating one example of an optical input signal to the automatic variable tilt apparatus according to the present disclosure;

FIGS. 3A and 3B are block diagrams illustrating a configuration example of variable tilt equalizers of the automatic variable tilt apparatus according to the present disclosure;

FIG. 4 is a block diagram illustrating a configuration example of a feedback controller of the automatic variable tilt apparatus according to the present disclosure;

FIG. 5 is a schematic diagram illustrating a state of an optical signal after gain equalization by the automatic variable tilt apparatus according to the present disclosure;

FIGS. 6A and 6B are block diagrams illustrating a connection example of the variable tilt equalizers after gain equalization by the automatic variable tilt apparatus according to the present disclosure;

FIG. 7 is a diagram simplifying a state of an optical signal after gain equalization by the automatic variable tilt apparatus according to the present disclosure and a connection of tilt equalizers; and

FIG. 8 is a flowchart illustrating one example of optical signal gain equalization processing performed by the automatic variable tilt apparatus according to the present disclosure.

### EXAMPLE EMBODIMENT

Example embodiments of the present disclosure will be described below with reference to the drawings. However, the present disclosure in the claims is not limited to the example embodiments below. Further, all configurations described in the example embodiments are not necessarily essential as means for solving the problems. For clarification of the description, the description and the drawings below are appropriately omitted and simplified. In each of the drawings, the same elements will be denoted by the same reference signs, and duplicate description will be omitted as necessary.

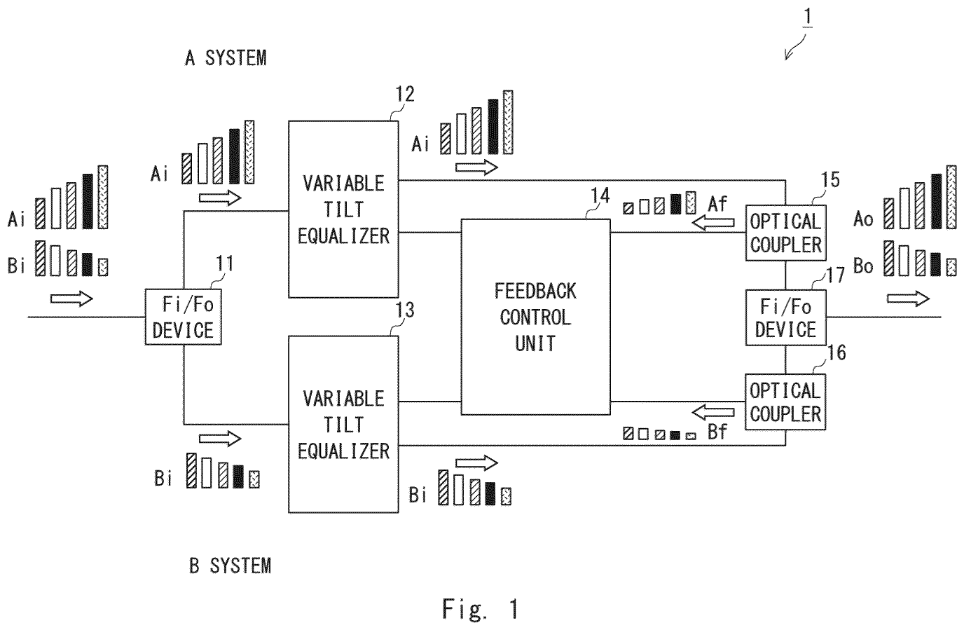

Hereinafter, an automatic variable tilt apparatus for a multicore fiber according to the present example embodiment will be described with reference to FIGS. 1 to 8. Before a configuration and an operation of the automatic variable tilt apparatus for a multicore fiber (hereinafter abbreviated as the “automatic variable tilt apparatus”) are described, circumstances that led to the present disclosure will be described.

<Circumstances that LED to Present Disclosure>

As also described in the background art, in an optical submarine system in which the number of optical fibers that can be mounted on an optical submarine cable is limited, there are problems that the number of optical fibers is difficult to increase and a manufacturing cost also becomes massive. Thus, in recent years, there is a movement to use, in optical communication, a C-band multicore fiber in which a plurality of cores are mounted on one optical fiber, and practical use is also desired in the optical submarine system.

Then, in the optical submarine system at a long-distance, in order to secure transmission quality of the multicore fiber, it is desirable to make a tilt level (inclination) of a profile (optical profile) of an optical signal flat, i.e., to adjust a tilt level of an optical profile to substantially 0 dB during system operation from beginning of life (BOL) to end of life (EOL).

However, a loss of a tilt level of the optical profile is increased due to repair on an optical submarine cable and aged deterioration of the optical submarine cable. Thus, in order to keep a tilt level flat during operation of the optical submarine system, a variable tilt equalizer apparatus that can freely adjust a tilt level of the optical profile needs to be provided.

Further, operation of a multicore system has been proceeding as a multi-conductor system that requires many signal lines, but system monitoring and tilt adjustment take time due to an increase in system signal lines. As a result, there is a problem that an operation cost of an optical submarine cable using a multicore fiber increases. Furthermore, there is also a demand to automate system monitoring and tilt adjustment.

For such problems, the inventor of the present application has come up with ideas of separating a multicore optical input signal being input from a multicore fiber into a plurality of single core optical input signals for a single mode fiber, feeding back a part of an optical output signal in each single mode fiber, and switching a plurality of tilt equalizers in a variable tilt equalizer. Hereinafter, an automatic variable tilt apparatus according to the present disclosure will be described.

### <Configuration of Automatic Variable Tilt Apparatus>

First, a configuration of the automatic variable tilt apparatus according to the present example embodiment will be described. The automatic variable tilt apparatus according to the present disclosure is one inserted between a multicore fiber and a multicore fiber in a multicore system. FIG. 1 is a block diagram illustrating a configuration example of an automatic variable tilt apparatus 1 according to the present disclosure. A configuration of the automatic variable tilt apparatus 1 according to the present example embodiment will be described with reference to FIG. 1.

Note that, in the present example, a case where a multicore fiber of two cores is used as a multicore fiber will be described. However, the present disclosure can also be applied to a case where a multicore fiber of three or more cores is used instead of a case where a multicore fiber of two cores is used. In that case, a processing system described below may be provided in the same number as a core number in association with the core number.

As illustrated in FIG. 1, the automatic variable tilt apparatus 1 includes a fan-in/fan-out device (hereinafter referred to as a Fi/Fo device) 11 on an input side, two variable tilt equalizers 12 and 13, a feedback controller 14, two optical couplers 15 and 16, and an Fi/Fo device 17 on an output side. A multicore optical input signal is input from a multicore fiber to the automatic variable tilt apparatus 1. Further, a system including the variable tilt equalizer 12 is assumed to be a system A, and a system including the variable tilt equalizer 13 is assumed to be a system B.

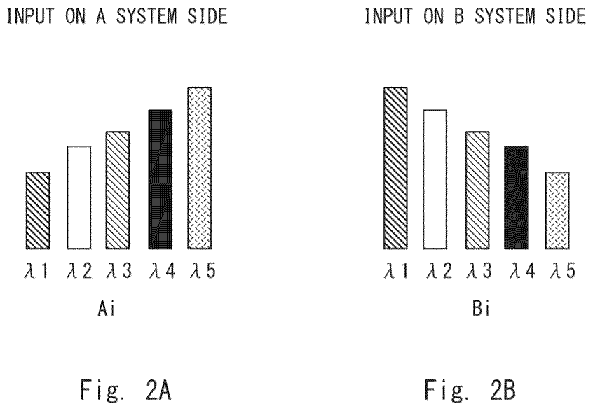

In the present example, the multicore fiber is formed of two single core optical input signals Ai and Bi. FIGS. 2A and 2B are diagrams illustrating one example of an optical input signal to the automatic variable tilt apparatus 1 according to the present disclosure. As illustrated in FIGS. 2A and 2B, each of the single core optical input signals Ai and Bi includes a spectrum formed of five wavelengths λ1 to λ5. Each of the wavelengths λ1 to λ5 is a center wavelength having a wavelength width in a predetermined range. Herein, the single core optical input signal Ai is assumed to have a characteristic in which a gain increases with a longer wavelength, and the single core optical input signal Bi is assumed to have a characteristic in which a gain decreases with a longer wavelength.

The Fi/Fo device 11 on the input side is configured to separate a multicore optical input signal Ai, Bi being input from the multicore fiber into the single core optical input signal Ai and the single core optical input signal Bi. Note that a signal line between the Fi/Fo device 11 and the Fi/Fo device 17 is a single mode fiber (SMF).

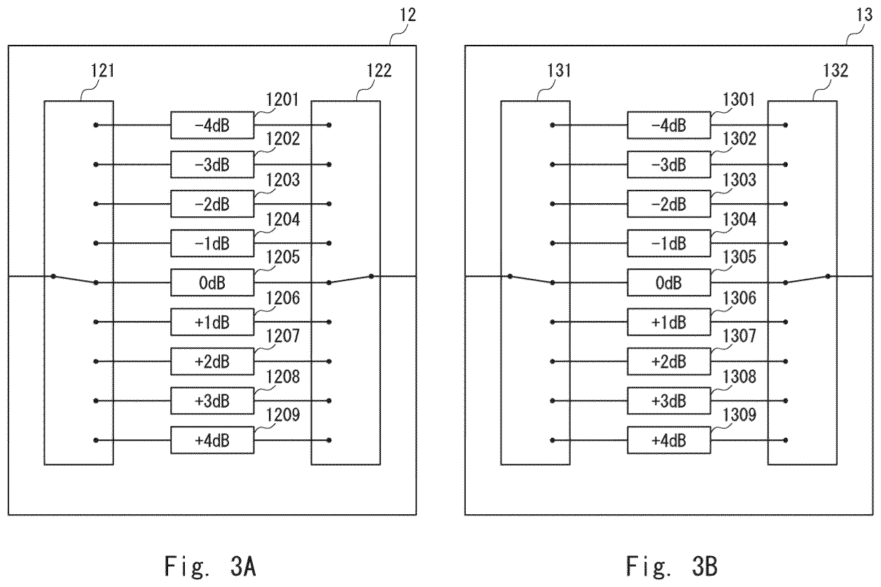

The single core optical input signal Ai is input to the variable tilt equalizer 12, and the single core optical input signal Bi is input to the variable tilt equalizer 13. The variable tilt equalizers 12 and 13 are configured to respectively adjust tilt (inclination) levels of the single core optical input signals Ai and Bi. FIGS. 3A and 3B are block diagrams illustrating a configuration example of the variable tilt equalizers 12 and 13 of the automatic variable tilt apparatus 1 according to the present disclosure.

As illustrated in FIG. 3A, the variable tilt equalizer 12 includes an optical switch (optical matrix switch) 121 on the input side, nine tilt equalizers 1201 to 1209 associated with nine kinds of gains, and an optical switch 122 on the output side. Switching among the tilt equalizers 1201 to 1209 by the optical switches 121 and 122 is controlled by the feedback controller 14.

The nine tilt equalizers 1201 to 1209 of the variable tilt equalizer 12 include the tilt equalizer 1205 having a gain of 0 dB, and the eight tilt equalizers 1201 to 1204 and 1206 to 1209 having a gain being set at a predetermined interval for positive and negative. Herein, the predetermined interval is 1 dB. In other words, the eight tilt equalizers 1201 to 1204 and 1206 to 1209 are the tilt equalizer 1201 having a gain of −4 dB, the tilt equalizer 1202 having a gain of −3 dB, the tilt equalizer 1203 having a gain of −2 dB, the tilt equalizer 1204 having a gain of −1 dB, the tilt equalizer 1206 having a gain of +1 dB, the tilt equalizer 1207 having a gain of +2 dB, the tilt equalizer 1208 having a gain of +3 dB, and the tilt equalizer 1209 having a gain of +4 dB.

Similarly, as illustrated in FIG. 3B, the variable tilt equalizer 13 includes an optical switch 131 on the input side, nine tilt equalizers 1301 to 1309 associated with nine kinds of gains, and an optical switch 132 on the output side. Switching among the tilt equalizers 1301 to 1309 by the optical switches 131 and 132 is controlled by the feedback controller 14.

The nine tilt equalizers 1301 to 1309 of the variable tilt equalizer 13 include the tilt equalizer 1305 having a gain of 0 dB, and the eight tilt equalizers 1301 to 1304 and 1306 to 1309 having a gain being set at a predetermined interval for positive and negative. Then, similarly to the variable tilt equalizer 12, the eight tilt equalizers 1301 to 1304 and 1306 to 1309 are the tilt equalizer 1301 having a gain of −4 dB, the tilt equalizer 1302 having a gain of −3 dB, the tilt equalizer 1303 having a gain of −2 dB, the tilt equalizer 1304 having a gain of −1 dB, the tilt equalizer 1306 having a gain of +1 dB, the tilt equalizer 1307 having a gain of +2 dB, the tilt equalizer 1308 having a gain of +3 dB, and the tilt equalizer 1309 having a gain of +4 dB.

Note that the number of the tilt equalizers included in each of the variable tilt equalizers 12 and 13 is not limited to nine. When the number of the tilt equalizers included in each of the variable tilt equalizers 12 and 13 is generalized, the number is 2N+1 (N is a positive integer). However, for example, N may be any of two to four in such a way as to prevent an increase in size of the entire automatic variable tilt apparatus 1. In other words, the number of the tilt equalizers included in each of the variable tilt equalizers 12 and 13 may be any of five, seven, and nine. Further, a predetermined interval between the tilt equalizers may be appropriately adjusted in accordance with the number of the tilt equalizers.

Here, as illustrated in FIGS. 3A and 3B, in an initial state, the variable tilt equalizer 12 selects the tilt equalizer 1205 having the gain of 0 dB, and the variable tilt equalizer 13 selects the tilt equalizer 1305 having the gain of 0 dB. In this way, as illustrated in FIG. 1, each of the variable tilt equalizers 12 and 13 outputs the input single core optical input signals Ai and Bi as they are.

The two optical couplers 15 and 16 are configured to respectively divide two single core optical output signals Ai and Bi from the two variable tilt equalizers 12 and 13 into two optical signals in a predetermined proportion. Here, the predetermined proportion may be, for example, 1:9 in consideration of intensity of an optical output signal on a subsequent stage, which is not limited thereto. Each of the optical couplers 15 and 16 outputs, to the feedback controller 14, a divided optical signal in a smaller proportion being one of the divided single core optical output signals Ai and Bi. In other words, each of the optical couplers 15 and 16 outputs optical feedback signals Af and Bf to the feedback controller 14.

Meanwhile, each of the optical couplers 15 and 16 outputs, to the Fi/Fo device 17, a divided optical signal in a greater proportion being another of the divided single core optical output signals Ai and Bi. In other words, each of the optical couplers 15 and 16 outputs single core optical output signals Ao and Bo to the Fi/Fo device 17.

The Fi/Fo device 17 on the output side is configured to multiplex the single core optical output signals Ao and Bo being divided by each of the two optical couplers 15 and 16, and output a multiplexed multicore optical output signals Ao, Bo.

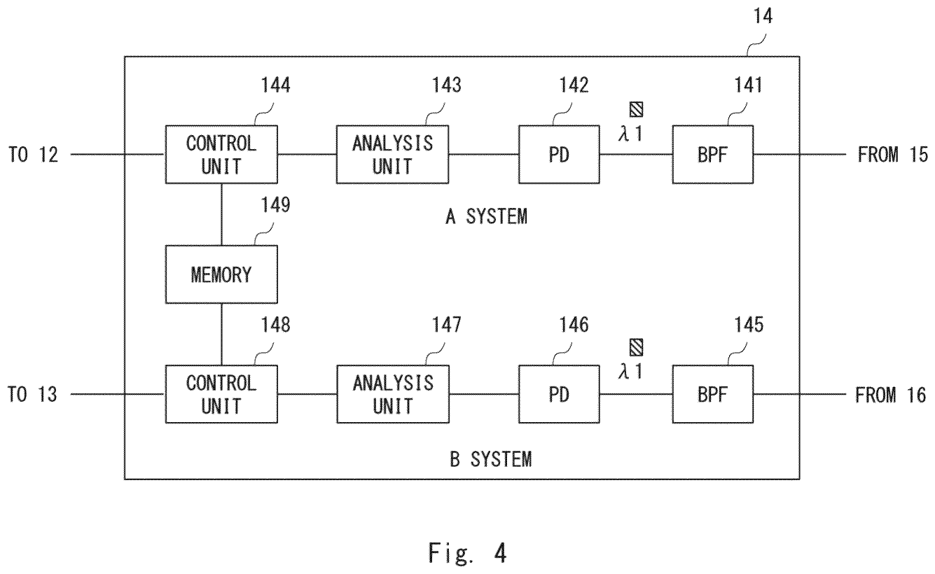

The feedback controller 14 is configured to perform feedback control on the associated variable tilt equalizers 12 and 13, based on a tilt level of the optical feedback signals Af and Bf being divided by each of the two optical couplers 15 and 16. Hereinafter, a configuration of the feedback controller 14 will be described with reference to FIG. 4. FIG. 4 is a block diagram illustrating a configuration example of the feedback controller 14 of the automatic variable tilt apparatus 1 according to the present disclosure.

As illustrated in FIG. 4, the feedback controller 14 includes a band-pass filter (BPF) 141, a photodiode (PD) 142, an analysis unit 143, and a control unit 144 in the A system, a band-pass filter (BPF) 145, a photodiode (PD) 146, an analysis unit 147, and a control unit 148 in the B system, and a memory 149.

The band-pass filters 141 and 145 are configured to each extract an optical signal having a specific wavelength (herein, an optical signal having the wavelength 21) from the optical feedback signals Af and Bf, and output the optical signal to the photodiodes 142 and 146. Specifically, the band-pass filters 141 and 145 are configured to extract, as an optical signal having a specific wavelength, an optical signal having the shortest wavelength λ1 from optical signals having the plurality of wavelengths λ1 to λ5, and output the optical signal to the photodiodes 142 and 146. The photodiodes 142 and 146 are configured to receive the optical signal having the specific wavelength 21, and each convert the optical signal into two electrical signals.

The analysis units 143 and 147 are configured to respectively analyze tilt levels of the single core optical input signals Ai and Bi, based on the two electrical signals associated with the optical signal having the specific wavelength 21. The memory 149 is configured to store a target tilt level. Here, the target tilt level means a tilt level at which a gain of an optical fiber is approximately fixed (0 dB) at each of the wavelengths λ1 to λ5 in an optical submarine system. The target tilt level is preset in accordance with a kind of an optical fiber to be used, a transmission distance, and the like, and is stored in the memory 149.

The control units 144 and 148 are configured to respectively select one of the plurality of tilt equalizers 1201 to 1209 and 1301 to 1309 of the associated variable tilt equalizers 12 and 13, based on an analysis result of each of the analysis units 143 and 147 and the target tilt level stored in the memory 149. Then, the control units 144 and 148 are configured to control the optical switches 121, 122, 131, and 132 of the variable tilt equalizers 12 and 13, based on the selected one tilt equalizer, and perform switching of the tilt equalizer.

### <Operation of Terminal Apparatus>

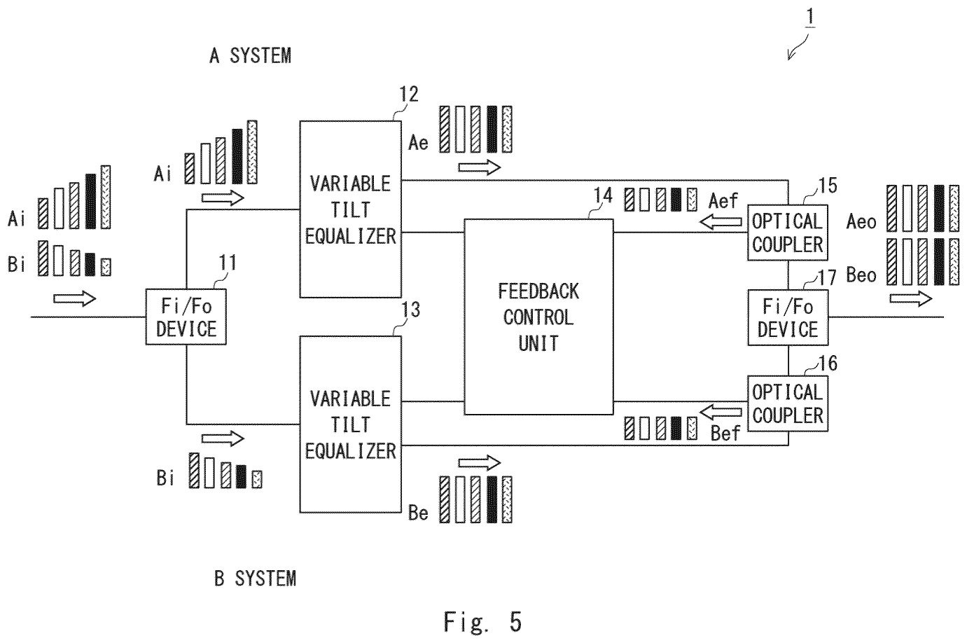

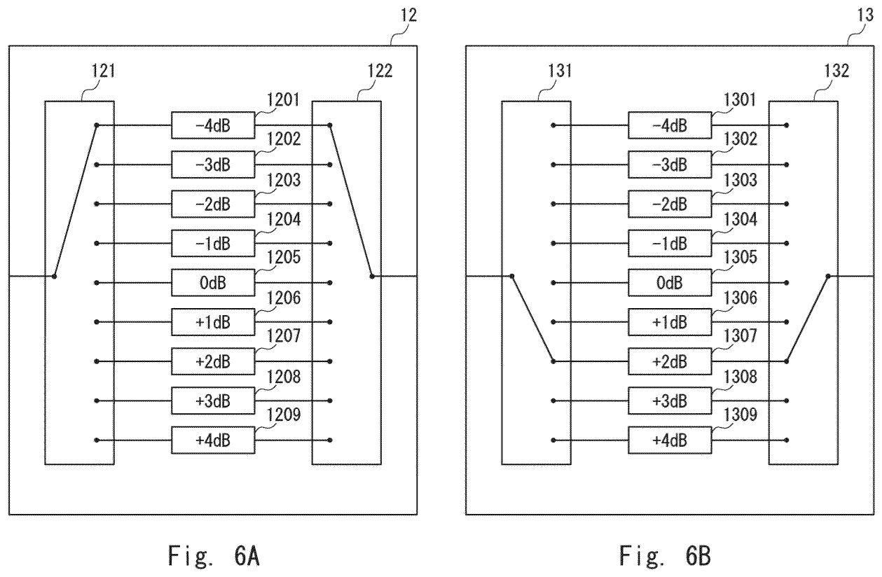

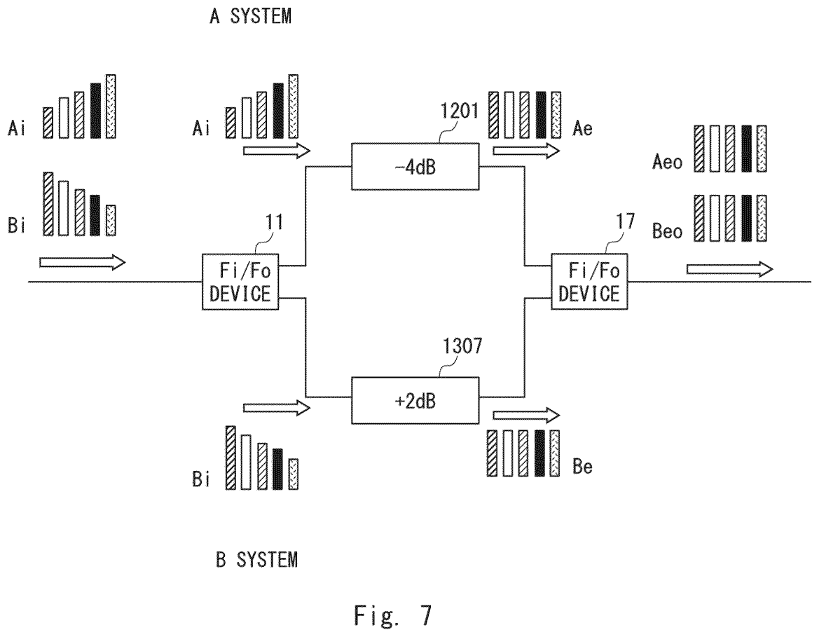

Next, one example of an operation of the automatic variable tilt apparatus 1 according to the present example embodiment will be described with reference to FIGS. 1 to 4 described above and FIGS. 5 to 7. In the present example embodiment, the automatic variable tilt apparatus 1 is assumed to perform an optical signal gain equalization method (optical signal gain equalization processing). Herein, an operation of each system of the A system and the B system will be described. FIG. 5 is a schematic diagram illustrating a state of an optical signal after gain equalization by the automatic variable tilt apparatus 1 according to the present disclosure. FIGS. 6A and 6B are block diagrams illustrating a connection example of the variable tilt equalizers after gain equalization by the automatic variable tilt apparatus 1 according to the present disclosure. FIG. 7 is a diagram simplifying a state of an optical signal after gain equalization by the automatic variable tilt apparatus 1 according to the present disclosure and a connection of the tilt equalizers.

The multicore optical input signal Ai, Bi is first input to the Fi/Fo device 11 from the multicore fiber in the multicore system, is separated into the single core optical input signal Ai and the single core optical input signal Bi by the Fi/Fo device 11, and is divided into two single mode fibers (SMFs). First, the description of the operation of the A system continues.

In the A system, the single core optical input signal Ai is input to the optical switch 121 of the variable tilt equalizer 12. Herein, as an initial stage, the tilt equalizer 1205 having the gain of 0 dB of the variable tilt equalizer 12 is selected, and communicates with the optical switch 122 (see FIG. 3A). Next, the single core optical input signal Ai is output as the single core optical output signal Ai from the variable tilt equalizer 12 via the tilt equalizer 1205 and the optical switch 122 (see FIG. 1).

Next, the single core optical output signal Ai is input to the optical coupler 15. In the optical coupler 15, the single core optical output signal Ai is divided into two optical signals in a predetermined proportion. A part of the divided single core optical output signal Ai is input as the optical feedback signal Af to the feedback controller 14.

Here, an optical signal having a specific wavelength needs to be extracted in order to acquire tilt information about the single core optical input signal Ai from the divided optical feedback signal Af. Thus, in the feedback controller 14, the optical feedback signal Af is input to the band-pass filter 141. The band-pass filter 141 extracts and outputs the optical signal having the specific wavelength 21. Next, the extracted optical signal having the specific wavelength λ1 is input to the photodiode 142. In the photodiode 142, the extracted optical signal having the specific wavelength λ1 is converted into an electrical signal, and the electrical signal is output.

The electrical signal is input to the analysis unit 143. The analysis unit 143 analyzes a tilt level of the single core optical input signal Ai, based on the electrical signal, and outputs an analysis result (analysis information). The analysis result of the analysis unit 143 is input to the control unit 144. When the control unit 144 accepts the tilt level of the single core optical input signal Ai being the analysis result of the analysis unit 143, the control unit 144 acquires target tilt information stored in the memory 149.

The control unit 144 compares the tilt level of the single core optical input signal Ai with the target tilt information, and calculates a needed tilt level adjustment amount in accordance with a comparison result. In the present example, the tilt level (inclination) of the single core optical input signal Ai is greater than a tilt level (inclination) of the single core optical input signal Bi, and the control unit 144 selects the tilt equalizer 1201 having the gain of −4 dB among the plurality of tilt equalizers 1201 to 1209 of the variable tilt equalizer 12 (see FIG. 6A). Next, the optical switches 121 and 122 of the variable tilt equalizer 12 switch from the tilt equalizer 1205 having the gain of 0 dB to the tilt equalizer 1201 having the gain of −4 dB in accordance with control of the control unit 144, and execution of the optical signal gain equalization method ends.

When such an operation of the A system ends, and the tilt equalizer 1201 according to the tilt level of the single core optical input signal Ai is selected, a spectrum of an optical signal as indicated in the A system in FIG. 5 is acquired. In other words, a tilt of a spectrum of the single core optical input signal Ai is adjusted by the variable tilt equalizer 12, and a single core optical output signal Ae after the tilt adjustment is output from the variable tilt equalizer 12. Here, as illustrated in FIG. 5, the single core optical output signal Ae includes a spectrum having substantially the same gain of each of the wavelengths λ1 to λ5.

Since an optical feedback signal Aef divided by the optical coupler 15 also has a flat tilt level having substantially the same gain of each of the wavelengths λ1 to λ5, an adjustment to the tilt level is not performed in the feedback controller 14, and the tilt equalizer 1201 having the gain of −4 dB is still selected in the variable tilt equalizer 12. Meanwhile, the rest of the single core optical output signal Ae after the tilt adjustment being divided by the optical coupler 15 is input, to the Fi/Fo device 17, as a single core optical output signal Aeo being a part of the multicore optical output signal of the automatic variable tilt apparatus 1.

Next, the operation of the B system will be described. In the B system, the single core optical input signal Bi is input to the optical switch 131 of the variable tilt equalizer 13. Herein, similarly to the A system, as an initial stage, the tilt equalizer 1305 having the gain of 0 dB of the variable tilt equalizer 13 is selected, and communicates with the optical switch 132 (see FIG. 3B). Next, the single core optical input signal Bi is output as the single core optical output signal Bi from the variable tilt equalizer 13 via the tilt equalizer 1305 and the optical switch 132 (see FIG. 1).

Next, the single core optical output signal Bi is input to the optical coupler 16. In the optical coupler 16, the single core optical output signal Bi is divided into two optical signals in a predetermined proportion. A part of the divided single core optical output signal Bi is input as the optical feedback signal Bf to the feedback controller 14.

Here, an optical signal having a specific wavelength needs to be extracted in order to acquire tilt information about the single core optical input signal Bi from the divided optical feedback signal Bf. Thus, in the feedback controller 14, the optical feedback signal Bf is input to the band-pass filter 145. The band-pass filter 145 extracts and outputs the optical signal having the specific wavelength 21. Next, the extracted optical signal having the specific wavelength λ1 is input to the photodiode 146. In the photodiode 146, the extracted optical signal having the specific wavelength λ1 is converted into an electrical signal, and the electrical signal is output.

The electrical signal is input to the analysis unit 147. The analysis unit 147 analyzes a tilt level of the single core optical input signal Bi, based on the electrical signal, and outputs an analysis result (analysis information). The analysis result of the analysis unit 147 is input to the control unit 148. When the control unit 148 accepts the tilt level of the single core optical input signal Bi being the analysis result of the analysis unit 147, the control unit 148 acquires target tilt information stored in the memory 149.

The control unit 148 compares the tilt level of the single core optical input signal Bi with the target tilt information, and calculates a needed tilt level adjustment amount in accordance with a comparison result. In the present example, the tilt level (inclination) of the single core optical input signal Bi is smaller than the tilt level (inclination) of the single core optical input signal Ai, and the control unit 148 selects the tilt equalizer 1307 having the gain of +2 dB among the plurality of tilt equalizers 1301 to 1309 of the variable tilt equalizer 13 (see FIG. 6B). Next, the optical switches 131 and 132 of the variable tilt equalizer 13 switch from the tilt equalizer 1305 having the gain of 0 dB to the tilt equalizer 1307 having the gain of +2 dB in accordance with control of the control unit 148, and execution of the optical signal gain equalization method ends.

When such an operation of the B system ends, and the tilt equalizer 1307 according to the tilt level of the single core optical input signal Bi is selected, a spectrum of an optical signal as indicated in the B system in FIG. 5 is acquired. In other words, a tilt of a spectrum of the single core optical input signal Bi is adjusted by the variable tilt equalizer 13, and a single core optical output signal Be after the tilt adjustment is output from the variable tilt equalizer 13. Here, as illustrated in FIG. 5, the single core optical output signal Be includes a spectrum having substantially the same gain of each of the wavelengths λ1 to λ5.

Since an optical feedback signal Bef divided by the optical coupler 16 also has a flat tilt level having substantially the same gain of each of the wavelengths λ1 to λ5, an adjustment to the tilt level is not performed in the feedback controller 14, and the tilt equalizer 1307 having the gain of +2 dB is still selected in the variable tilt equalizer 13. Meanwhile, the rest of the single core optical output signal Be after the tilt adjustment being divided by the optical coupler 16 is input, to the Fi/Fo device 17, as a single core optical output signal Beo being a part of the multicore optical output signal of the automatic variable tilt apparatus 1.

In the end, the single core optical output signal Aeo being input from the optical coupler 15 and the single core optical output signal Beo being input from the optical coupler 16 are multiplexed by the Fi/Fo device 17, and a multiplexed multicore optical output signal Aeo, Beo is output from the Fi/Fo device 17 (see FIG. 5).

For a series of the operations of the optical signal gain equalization method described above, a state of an optical signal after gain equalization by the automatic variable tilt apparatus 1 and a connection of the tilt equalizers will be briefly described by using FIG. 7. First, the multicore optical input signal Ai, Bi is input to the Fi/Fo device 11 from the multicore fiber in the multicore system, and is separated into the single core optical input signal Ai and the single core optical input signal Bi.

Next, the single core optical input signal Ai is input to the tilt equalizer 1201 having the gain of −4 dB, and the single core optical output signal Ae after the tilt adjustment having a flat tilt level is output. Meanwhile, the single core optical input signal Bi is input to the tilt equalizer 1307 having the gain of +2 dB, and the single core optical output signal Be after the tilt adjustment having a flat tilt level is output.

In the end, although not illustrated, the single core optical output signals Aeo and Beo being a difference between the optical feedback signals Aef and Bef are input to the Fi/Fo device 17, and the multicore optical output signal Aeo, Beo is output from the Fi/Fo device 17 after multiplexing by the Fi/Fo device 17.

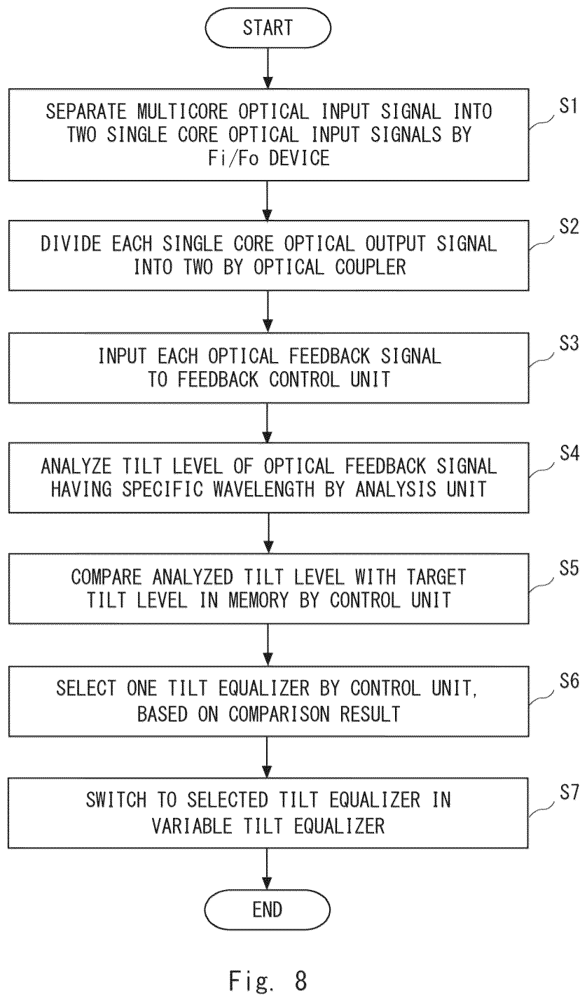

Next, an operation of the automatic variable tilt apparatus 1 will be described again with reference to a flowchart illustrated in FIG. 8. FIG. 8 is the flowchart illustrating one example of the optical signal gain equalization processing performed by the automatic variable tilt apparatus 1 according to the present disclosure.

The automatic variable tilt apparatus 1 according to the present example embodiment performs the optical signal gain equalization processing, for example, at any timing or at all times. When the optical signal gain equalization processing stars, the multicore optical input signal Ai, Bi from the multicore fiber in the multicore system is first separated by the Fi/Fo device 11 into the two single core optical input signals Ai and Bi (step S1).

Next, each of the single core optical output signals Ai and Bi being output from each of the variable tilt equalizers 12 and 13 are divided by the optical couplers 15 and 16 into two optical signals (i.e., the single core optical output signals Ao and Bo and the optical feedback signals Af and Bf) (step S2).

Next, the optical feedback signals Af and Bf are input to the feedback controller 14 (step S3), and a tilt level of an optical signal having the specific wavelength λ1 being extracted by each of the band-pass filters 141 and 145 is analyzed by the analysis units 143 and 147 in the feedback controller 14 (step S4).

Next, the tilt level being analyzed by the analysis units 143 and 147 is compared with a target tilt level being stored in the memory 149 by the control units 144 and 148 (step S5), and a needed tilt level adjustment amount is calculated in accordance with a comparison result. Then, one tilt equalizer in each of the variable tilt equalizers 12 and 13 is selected by the control units 144 and 148, based on a comparison result (tilt level adjustment amount) (step S6).

Next, switching of a connection to the one tilt equalizer selected in each of the variable tilt equalizers 12 and 13 is performed in accordance with control of the control units 144 and 148 (step S7), and the optical signal gain equalization processing ends.

As described above, the automatic variable tilt apparatus 1 according to the present example embodiment includes: the first fan-in/fan-out device 11 configured to separate the multicore optical input signal Ai, Bi from a multicore fiber into the two single core optical input signals Ai and Bi; the two variable tilt equalizers 12 and 13 configured to respectively adjust tilt levels of the two single core optical input signals Ai and Bi; the two optical couplers 15 and 16 configured to respectively divide the two single core optical output signals Ai and Bi or Ae and Be from the two variable tilt equalizers 12 and 13 into the two optical signals Ao, Af and Bo, Bf, or Aeo, Aef and Beo, Bef in a predetermined proportion; the feedback controller 14 configured to perform feedback control on the associated variable tilt equalizers 12 and 13, based on a tilt level of one Af, Bf of the single core optical output signals being divided by each of the two optical couplers 15 and 16; and the second fan-in/fan-out device 17 configured to multiplex another Ao, Bo, or Aeo, Beo of the single core optical output signals being divided by each of the two optical couplers 15 and 16, and output the multiplexed multicore optical output signal Ao, Bo, or Aeo, Beo. The automatic variable tilt apparatus 1 is configured in such a manner, and thus a gain of the variable tilt equalizers 12 and 13 can be changed in accordance with control of the feedback controller 14, and a tilt level of the single core optical input signals Ai and Bi can be thus automatically adjusted to be flat. In this way, the automatic variable tilt apparatus 1 according to the present example embodiment can automatically adjust a tilt level (inclination) of an optical profile (spectrum) being an optical input signal in a short time in an optical submarine system using a multicore fiber. Then, monitoring of the optical submarine system can be simplified by automatically adjusting the optical profile (spectrum).

Further, in the automatic variable tilt apparatus 1 according to the present example embodiment, in association with each of the two single core optical output signals Ai and Bi, the feedback controller 14 includes the two band-pass filters 141 and 145 configured to each extract an optical signal having the specific wavelength λ1 from one Af, Bf of the single core optical output signals, and output the optical signal, the two photodiodes 142 and 146 configured to receive the two optical signals having the specific wavelength λ1, and each convert the two optical signals into two electrical signals, the two analysis units 143 and 147 configured to respectively analyze tilt levels of the two single core optical input signals Ai and Bi, based on the two electrical signals, the memory 149 configured to store a target tilt level, and the two control units 144 and 148 configured to respectively select one tilt equalizer in each of the variable tilt equalizers 12 and 13, based on an analysis result of the analysis units 143 and 147 and the target tilt level, and control switching of the tilt equalizer in the variable tilt equalizers 12 and 13. Further, each of the two variable tilt equalizers 12 and 13 includes the plurality of tilt equalizers 1201 to 1209 and 1301 to 1309 associated with a plurality of gains, and the optical switches 121, 122, 131, and 132 associated with the number of the plurality of tilt equalizers 1201 to 1209 and 1301 to 1309. The automatic variable tilt apparatus 1 according to the present example embodiment is configured in such a manner, and thus a tilt level of the single core optical input signals Ai and Bi can be automatically adjusted to be flat by switching a small number of the tilt equalizers in addition to the effects described above.

Further, an optical signal gain equalization method includes: by the first fan-in/fan-out device 11, separating the multicore optical input signal Ai, Bi from a multicore fiber into the two single core optical input signals Ai and Bi; inputting each of the two single core optical input signals Ai and Bi to the two variable tilt equalizers 12 and 13; by each of the two optical couplers 15 and 16, dividing the single core optical output signals Ai and Bi from the associated variable tilt equalizers 12 and 13 into two optical signals in a predetermined proportion; performing feedback control on the associated variable tilt equalizers 12 and 13, based on a tilt level of one Af, Bf of the single core optical output signals being divided by each of the two optical couplers 15 and 16; and, by the second fan-in/fan-out device 17, multiplexing another Aeo, Beo of the single core optical output signals being divided by each of the two optical couplers 15 and 16, and outputting the multiplexed multicore optical output signal Aeo, Beo. The optical signal gain equalization method is configured in such a manner, and thus an effect similar to that of the automatic variable tilt apparatus 1 according to the present example embodiment can be achieved.

A part or the whole of the processing in the feedback controller 14, particularly the analysis units 143 and 147 and the control units 144 and 148 of the automatic variable tilt apparatus 1 described above can be achieved as a computer program that can be installed in the automatic variable tilt apparatus 1. Such a program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The present disclosure can provide an automatic variable tilt apparatus, an optical signal gain equalization method, and a non-transitory computer readable medium that stores a program, which can automatically adjust a tilt level (inclination) of an optical profile being an optical input signal in a short time in an optical submarine system using a multicore fiber.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

A part or the whole of the above-mentioned example embodiments may be described in supplementary notes below, which is not limited thereto.

### (Supplementary Note 1)

An automatic variable tilt apparatus including:
a first fan-in/fan-out device configured to separate a multicore optical input signal from a multicore fiber into two single core optical input signals;
two variable tilt equalizers configured to respectively adjust tilt levels of the two single core optical input signals;
two optical couplers configured to respectively divide two single core optical output signals from the two variable tilt equalizers into two optical signals in a predetermined proportion;
a feedback controller configured to perform feedback control on the associated variable tilt equalizer, based on a tilt level of one of the single core optical output signals being divided by each of the two optical couplers; and
a second fan-in/fan-out device configured to multiplex another of the single core optical output signals being divided by each of the two optical couplers, and output a multiplexed multicore optical output signal.

### (Supplementary Note 2)

The automatic variable tilt apparatus according to supplementary note 1, wherein
each of the two variable tilt equalizers includes a plurality of tilt equalizers associated with a plurality of gains, and an optical switch associated with the number of the plurality of tilt equalizers,
the feedback controller selects one tilt equalizer from the plurality of tilt equalizers of each of the two variable tilt equalizers, based on a tilt level of one of the associated single core optical output signals, and
the optical switch of each of the two variable tilt equalizers switches to the selected one tilt equalizer.

### (Supplementary Note 3)

The automatic variable tilt apparatus according to supplementary note 2, wherein,
in association with each of the two single core optical output signals, the feedback controller includes
two band-pass filters configured to each extract an optical signal having a specific wavelength from one of the single core optical output signals, and output the optical signal,
two photodiodes configured to receive the two optical signals having the specific wavelength, and each convert the two optical signals into two electrical signals,
two analysis units configured to respectively analyze tilt levels of the two single core optical input signals, based on the two electrical signals,
a memory configured to store a target tilt level, and
two control units configured to respectively select the one tilt equalizer, based on an analysis result of the analysis unit and the target tilt level, and control switching of the tilt equalizer in the variable tilt equalizer.

### (Supplementary Note 4)

The automatic variable tilt apparatus according to supplementary note 3, wherein
each of the two single core optical input signals is formed of optical signals having a plurality of wavelengths, and
the two band-pass filters extract, as an optical signal having the specific wavelength, an optical signal having the shortest wavelength from the optical signals having the plurality of wavelengths.

### (Supplementary Note 5)

The automatic variable tilt apparatus according to supplementary note 3, wherein each of the two control units compares an analysis result of the associated analysis unit with the target tilt level, calculates a tilt level adjustment amount, and selects the one tilt equalizer, based on the tilt level adjustment amount.

### (Supplementary Note 6)

The automatic variable tilt apparatus according to any one of supplementary notes 2 to 5, wherein the plurality of tilt equalizers include a tilt equalizer having a gain of 0 dB, and 2N (N is a positive integer) tilt equalizers having a gain being set at a predetermined interval for positive and negative.

### (Supplementary Note 7)

The automatic variable tilt apparatus according to supplementary note 6, wherein the N is any of two to four.

### (Supplementary Note 8)

An optical signal gain equalization method including:
by a first fan-in/fan-out device, separating a multicore optical input signal from a multicore fiber into two single core optical input signals;
inputting each of the two single core optical input signals to two variable tilt equalizers;
by each of two optical couplers, dividing a single core optical output signal from the associated variable tilt equalizer into two optical signals in a predetermined proportion;
performing feedback control on the associated variable tilt equalizer, based on a tilt level of one of the single core optical output signals being divided by each of the two optical couplers; and,
by a second fan-in/fan-out device, multiplexing another of the single core optical output signals being divided by each of the two optical couplers, and outputting a multiplexed multicore optical output signal.

### (Supplementary Note 9)

The optical signal gain equalization method according to supplementary note 8, wherein
each of the two variable tilt equalizers includes a plurality of tilt equalizers associated with a plurality of gains, and an optical switch associated with the number of the plurality of tilt equalizers, and,
in the feedback control, the optical signal gain equalization method further includes selecting one tilt equalizer from the plurality of tilt equalizers of each of the two variable tilt equalizers, based on a tilt level of one of the associated single core optical output signals, and, by the optical switch, switching to the selected one tilt equalizer.

### (Supplementary Note 10)

The optical signal gain equalization method according to supplementary note 9, further including:
in the feedback control, in association with each of the two single core optical input signals,
extracting an optical signal having a specific wavelength from one of the single core optical output signals;
converting two optical signals having the specific wavelength into two electrical signals;
analyzing a tilt level of each of the two single core optical input signals, based on the two electrical signals; and
each selecting the one tilt equalizer, based on a target tilt level stored in a memory and an analysis result by the analysis, and switching to the selected one tilt equalizer.

### (Supplementary Note 11)

The optical signal gain equalization method according to supplementary note 10, wherein
each of the two single core optical input signals is formed of optical signals having a plurality of wavelengths, and
the optical signal gain equalization method further includes extracting, as an optical signal having the specific wavelength, an optical signal having the shortest wavelength from the optical signals having the plurality of wavelengths.

### (Supplementary Note 12)

The optical signal gain equalization method according to supplementary note 10, further including:
in the step of switching to the selected one tilt equalizer,
comparing an analysis result by the analysis with the target tilt level, and calculating a tilt level adjustment amount; and
selecting the one tilt equalizer, based on the tilt level adjustment amount.

### (Supplementary Note 13)

A non-transitory computer readable medium that stores a program causing a computer to execute:
extracting an optical signal having a specific wavelength from a part of each of two single core optical input signals being separated from a multicore optical input signal by a fan-in/fan-out device;
converting two optical signals having the specific wavelength into two electrical signals;
analyzing a tilt level of each of the two single core optical input signals, based on the two electrical signals;
each selecting one tilt equalizer from a plurality of tilt equalizers in each of two variable tilt equalizers, based on a target tilt level stored in a memory and an analysis result by the analysis, and switching to the selected one tilt equalizer; and
multiplexing two optical output signals being output from the two variable tilt equalizers after the switching, and outputting a multiplexed multicore optical output signal.

What is claimed is:

1. An automatic variable tilt apparatus comprising:
a first fan-in/fan-out device configured to separate a multicore optical input signal from a multicore fiber into two single core optical input signals;
two variable tilt equalizers configured to respectively adjust tilt levels of the two single core optical input signals;
two optical couplers configured to respectively divide two single core optical output signals from the two variable tilt equalizers into two optical signals in a predetermined proportion;
a feedback controller configured to perform feedback control on the associated variable tilt equalizer, based on a tilt level of one of the single core optical output signals being divided by each of the two optical couplers; and
a second fan-in/fan-out device configured to multiplex another of the single core optical output signals being divided by each of the two optical couplers, and output a multiplexed multicore optical output signal.

2. The automatic variable tilt apparatus according to claim 1, wherein
each of the two variable tilt equalizers includes a plurality of tilt equalizers associated with a plurality of gains, and an optical switch associated with the number of the plurality of tilt equalizers,
the feedback controller selects one tilt equalizer from the plurality of tilt equalizers of each of the two variable tilt equalizers, based on a tilt level of one of the associated single core optical output signals, and
the optical switch of each of the two variable tilt equalizers switches to the selected one tilt equalizer.

3. The automatic variable tilt apparatus according to claim 2, wherein,
the feedback controller includes, in association with each of the two single core optical output signals,
two band-pass filters configured to each extract an optical signal having a specific wavelength from one of the single core optical output signals, and output the optical signal,
two photodiodes configured to receive two optical signals having the specific wavelength, and convert the two optical signals into two electrical signals,
two analysis units configured to respectively analyze tilt levels of the two single core optical input signals, based on the two electrical signals,
a memory configured to store a target tilt level, and
two control units configured to respectively select the one tilt equalizer, based on an analysis result of the analysis unit and the target tilt level, and control switching of the tilt equalizer in the variable tilt equalizer.

4. The automatic variable tilt apparatus according to claim 3, wherein
each of the two single core optical input signals is formed of optical signals having a plurality of wavelengths, and
the two band-pass filters extract, as an optical signal having the specific wavelength, an optical signal having the shortest wavelength from the optical signals having the plurality of wavelengths.

5. The automatic variable tilt apparatus according to claim 3, wherein each of the two control units compares an analysis result of the associated analysis unit with the target tilt level, calculates a tilt level adjustment amount, and selects the one tilt equalizer, based on the tilt level adjustment amount.

6. The automatic variable tilt apparatus according to claim 2, wherein the plurality of tilt equalizers include a tilt equalizer having a gain of 0 dB, and 2N (N is a positive integer) tilt equalizers having a gain being set at a predetermined interval for positive and negative.

7. The automatic variable tilt apparatus according to claim 6, wherein the N is any of two to four.

8. An optical signal gain equalization method comprising:
by a first fan-in/fan-out device, separating a multicore optical input signal from a multicore fiber into two single core optical input signals;
inputting each of the two single core optical input signals to two variable tilt equalizers;
by each of two optical couplers, dividing a single core optical output signal from the associated variable tilt equalizer into two optical signals in a predetermined proportion;
performing feedback control on the associated variable tilt equalizer, based on a tilt level of one of the single core optical output signals being divided by each of the two optical couplers; and,
by a second fan-in/fan-out device, multiplexing another of the single core optical output signals being divided by each of the two optical couplers, and outputting a multiplexed multicore optical output signal.

9. The optical signal gain equalization method according to claim 8, wherein
each of the two variable tilt equalizers includes a plurality of tilt equalizers associated with a plurality of gains, and an optical switch associated with the number of the plurality of tilt equalizers, and,
in the feedback control, the optical signal gain equalization method further comprises selecting one tilt equalizer from the plurality of tilt equalizers of each of the two variable tilt equalizers, based on a tilt level of one of the associated single core optical output signals, and, by the optical switch, switching to the selected one tilt equalizer.

10. The optical signal gain equalization method according to claim 9, further comprising:
in the feedback control, in association with each of the two single core optical input signals,
extracting an optical signal having a specific wavelength from one of the single core optical output signals;
converting two optical signals having the specific wavelength into two electrical signals;
analyzing a tilt level of each of the two single core optical input signals, based on the two electrical signals; and
each selecting the one tilt equalizer, based on a target tilt level stored in a memory and an analysis result by the analysis, and switching to the selected one tilt equalizer.

11. The optical signal gain equalization method according to claim 10, wherein
each of the two single core optical input signals is formed of optical signals having a plurality of wavelengths, and
the optical signal gain equalization method further comprises extracting, as an optical signal having the specific wavelength, an optical signal having the shortest wavelength from the optical signals having the plurality of wavelengths.

12. The optical signal gain equalization method according to claim 10, further comprising:
in the step of switching to the selected one tilt equalizer,
comparing an analysis result by the analysis with the target tilt level, and calculating a tilt level adjustment amount; and
selecting the one tilt equalizer, based on the tilt level adjustment amount.

13. A non-transitory computer readable medium that stores a program causing a computer to execute:
extracting an optical signal having a specific wavelength from a part of each of two single core optical input signals being separated from a multicore optical input signal by a fan-in/fan-out device;
converting two optical signals having the specific wavelength into two electrical signals;
analyzing a tilt level of each of the two single core optical input signals, based on the two electrical signals;
each selecting one tilt equalizer from a plurality of tilt equalizers in each of two variable tilt equalizers, based on a target tilt level stored in a memory and an analysis result by the analysis, and switching to the selected one tilt equalizer; and
multiplexing two optical output signals being output from the two variable tilt equalizers after the switching, and outputting a multiplexed multicore optical output signal.
